(19) United States
(12) Patent Application Publication
(10) Pub. No.: US 2005/0030779 A1
(43) Pub. Date: Feb. 10, 2005

(54) Controlling circuit for a pulse width modulated DC/DC converter

(75) Inventor: Weiwen Feng, Taipei (TW)

Correspondence Address: Haverstock & Owens LLP, 162 North Wolfe Road, Sunnyvale, CA, 94086, US

(73) Assignee: Analog Integrations Corporation

(21) Appl. No.: 10/899,935

(22) Filed: Jul. 26, 2004

(30) Foreign Application Priority Data
Aug. 7, 2003 (TW) 092121726

(51) Int. Cl. H02M 5/293

(52) U.S. Cl. 363/163

(57) ABSTRACT

A controlling circuit for a pulse width modulated DC/DC converter is provided in the present application. The controlling circuit includes a current amplifier, a compensator, a comparator, a latch circuit, a clock generator, a driving circuit, and a differential amplifier and is more compact than the conventional ones.

### FIELD OF THE INVENTION

The present application is related to a controlling circuit and the method for controlling a DC/DC converter, in particular to a controlling circuit and the method for controlling a pulse width modulated DC/DC converter

### BACKGROUND OF THE INVENTION

Controlling methods related to the PWM (Pulse Width Modulation) technique are widely used for controlling the spinning rate of a DC motor. Besides, such methods are further applied in the power supply regulating and the DC/AC converting.

The spinning rate of the motor is able to be adjusted by modulating the width of the relative time period of a high-potential pulse. Therefore, such a controlling method is called a method related to the PWM technique.

Please refer to FIG. 1, which illustrates a conventional controlling circuit of the pulse width modulated DC/DC converter. Such controlling circuit has the current amplifier 11, the compensator 12, the first switch 13, the clock generator 14, the controlling circuit 15, the differential amplifier 16, the comparator 17, the R-S latch circuit 18, the NAND (Not AND) gate 19, the driving circuit 110, the second switch 111 and the step-down circuit 112. The output terminal of the current amplifier 11 is electrically connected one input terminal of the compensator 12 and the clock generator 14 is electrically connected to the other input terminal thereof. Furthermore, the output terminal of the compensator 12 is electrically connected to a first terminal of the first switch 13. In addition to the first terminal, the first switch 13 further has a second terminal and a third terminal, which are respectively electrically connected to a non-inverting input terminal of the comparator 17 and the clock generator 14. The output terminal of the comparator 17 is electrically connected to the R-S latch circuit 18. The clock generator 14 is further connected to the R-S latch circuit 18 and the controlling circuit 15. Additionally, the NAND gate 19 is configured to receive the output signal GDRI from the R-S latch circuit 18 and the output signal of the controlling circuit 15, and to generate an output signal forwarded to the driving circuit 110. The driving circuit 110 is electrically connected to a first terminal of the second switch 111, and a second terminal and a third terminal thereof are respectively connected to a non-inverting input terminal of the current amplifier 11 and the step-down circuit 112. An output voltage Vₒᵤₜ from the step-down circuit 112 is forwarded to the differential amplifier 16 and received thereby. The differential amplifier 16 is configured to generate a compared voltage V_{C} forwarded to the non-inverting terminal of the comparator 17 in response to the output voltage Vₒᵤₜ from the step-down circuit 112 and a reference voltage V_{ref}.

The step-down circuit 112 is constructed of an inductor L, a Zener diode D and a capacitor C2. The inductor L is electrically connected between the cathode of the Zener diode D and a first terminal of the capacitor C2, and a second terminal of the capacitor C2 is connected to the anode of the Zener diode D. Based on the above, such a pulse width modulated DC/DC converter in this case is related to a current mode. The waveforms of various output signals consisting of V_{C}, CURS2, CURS, SET, RESET and GDRI are further measured and illustrated in the following.

Please refer to FIG. 2 illustrating the measured waveforms of various output signals consisting of V_{C}, CURS2, CURS, SET, RESET and GDRI in the conventional controlling circuit shown in FIG. 1. A parasitic capacitance is induced between the gate and the drain of the second switch 111 due that the second switch 111 is a MOSFET, and the charging effect of the parasitic capacitance further results in an error current signal and hence initiates an error operation of the converter (not shown). Therefore, in order to induce an effect of a proceeding shield for preventing the erroneous converter operating, an additional circuit or switch is always necessary for the conventional pulse width modulated DC/DC converter.

Referring FIG. 1 and FIG. 2 again, the working principle of the conventional DC/DC converter is further illustrated as follows.

First, the current amplifier 11 generates an output signal in response to an input voltage Vᵢₙ and a value come from the second terminal of the second switch 111, and the output signal from the current amplifier 11 is input to the compensator 12 with a sawtooth wave generated by the clock generator 14. The compensator 12 generates an output signal CURS2 having a waveform as shown in FIG. 2 in response to the output signal from the current amplifier 11 and the sawtooth wave.

The first switch 13 is configured in the conventional controlling circuit to induce the effect of the proceeding shield for preventing the converter erroneously operated as mentioned. The influence of the error signal is preventable by a delayed output signal CURS outputting, which is controlled by the first switch 13. The delayed output signal CURS is forwarded to the comparator 17, which compares the delayed output signal CURS with the compared voltage V_{C} and generates a reset signal RESET, wherein the reset signal RESET is at a high-potential state if the compared voltage V_{C} has a higher potential than that of the delayed output signal CURS, and at a low-potential state if otherwise. Then the reset signal RESET and the set signal SET generated by the clock generator 14 are simultaneously input to the R-S latch circuit 18 and the R-S latch circuit 18 would generate an output signal GDRI, accordingly.

As shown in FIG. 2, the waveform of the output signal GDRI from the R-S latch circuit 18 is transformed while the set signal SET or the reset signal RESET transforms from a high-potential state into a low-potential state. In other words, the potential state of the output signal GDRI is transformed in response to a control of the set signal SET or the reset signal RESET.

Secondly, the output signal GDRI from the R-S latch circuit 18 and a control signal generated by the controlling circuit 15 are simultaneously forwarded to the NAND gate 19 as an input thereof. The controlling circuit 15 is configured to drive the converter to be operated in a power-saving mode while the converter is operated in the light load for improving the efficiency. The output signal from the NAND gate 19 has an inverting potential to that of the output signal GDRI if the control signal from the controlling circuit 15 is in a high-potential state; on the other hand, the potential of the output signal from the NAND gate 19 would maintain at a high-potential state if the control signal from the controlling circuit 15 has a low-potential state. Therefore, the NAND gate 19 outputting is changeable by adjusting the control signal. The efficiency in the light load is hence improved and the purpose for the converter operating in a power-saving mode is further achieved.

The conventional controlling circuit for the pulse width modulated DC/DC converter has a driving circuit 110 for driving an outputting of the NAND gate 19 to control the second switch 111 and moreover, to control the current amplifier 11 and the step-down circuit 112. The output voltage Vₒᵤₜ from the step-sown circuit 112 is forwarded back to the differential amplifier 16 and input thereto with a reference voltage V_{ref}. Hence the differential amplifier 16 would generate the compared voltage V_{C} in response to the reference voltage V_{ref} and the output voltage Vₒᵤₜ from the step-down circuit 112. Accordingly, the compared voltage V_{C} from the differential amplifier 16 is compared with the delayed output signal CURS from the first switch 13 through the comparator 17 to make the modulation of the pulse width proceeding.

Based on the foregoing, in order to prevent the charging effect of the parasitic capacitance and the erroneous converter operating initiated by an error current signal resulted therefrom, an additional circuit or switch, such as the first switch 13, is necessary to be applied for inducing an effect of a proceeding shield in the conventional controlling circuit for the pulse width modulated DC/DC converter. Additionally, another additional circuit, such as the controlling circuit 15, is also needed to drive the converter operating in a power-saving mode while the converter is in a light-load state. The above additional circuit arranging always makes the controlling circuit more complicated, which needs to be overcome.

In order to overcome the drawbacks in the prior art, a controlling circuit, in particular, a controlling circuit for controlling a pulse width modulated DC/DC converter is provided.

### SUMMARY OF THE INVENTION

In accordance with a first aspect of the present application, a clock generator with a set signal with a modulatable width for using in a controlling circuit of a pulse width modulated DC/DC converter is provided. The clock generator generates a set signal for controlling the DC/DC converter.

Preferably, the set signal has a first waveform with a first low-potential pulse while being in a heavy-load state for preventing an error operation of the DC/DC converter, and a second waveform of a second low-potential pulse while being in a light-load state for setting a minimum time of operation for driving the converter into a power-saving mode.

Preferably, the second low-potential pulse has a width larger than that of the first low-potential pulse.

In accordance with a second aspect of the present application, a controlling circuit is provided. The controlling circuit has a current amplifier outputting an output signal in response to an input voltage, a compensator electrically connected to the current amplifier and generating an output signal in response to the output signal from the current amplifier and a modulation signal, a comparator electrically connected to the compensator for comparing the output signal from the compensator with the output signal from the current amplifier and generating a reset signal in response to a compared result, a latch circuit electrically connected to the comparator and generating an output signal in response to a control of the reset signal and a set signal, a clock generator electrically connected to the compensator and the latch circuit to generate the modulation signal and the set signal, a driving circuit electrically connected to the latch circuit and generating a driving signal in response to the output signal from the latch circuit, so as to drive a switch to generate a switch signal for controlling the current amplifier and a step-down circuit, and a differential amplifier electrically connected to the step-down circuit and generating an output signal in response to a control of an output voltage from the step-down circuit and a reference voltage.

Preferably, the set signal has a first waveform with a first low-potential pulse while in a heavy-load state to prevent the reset signal from being changed in response to the output signal from the latch circuit while the set signal functions, for preventing an error operation of the converter resulting from erroneously comparing an output signal from the compensator with the output signal from the current amplifier, and the set signal has a second waveform with a second low-potential pulse while being in a light-load state to set a minimum time of operation for driving the converter into a power-saving mode.

Preferably, the controlling circuit is used for controlling a pulse width modulated DC/DC converter.

Preferably, the current amplifier has a non-inverting input terminal and an inverting input terminal and a resistor is connected therebetween, and the input voltage is input to the non-inverting input terminal of the current amplifier.

Preferably, the switch signal is input to the inverting input terminal of the current amplifier.

Preferably, the modulated signal is a sawtooth wave.

Preferably, the latch circuit is an R-S latch circuit.

Preferably, the clock generator is capable of modulating a width of the set signal.

Preferably, the second low-potential pulse has a width larger than that of the first low-potential pulse.

Preferably, the switch is a MOSFET (metal oxide semiconductor field effect transistor).

Preferably, the step-down circuit has an inductor, a Zener diode and a capacitor.

Preferably, the inductor has two ends respectively connected to a cathode end of the Zener diode and a first end of the capacitor, and a second end of the capacitor is connected to an anode end of the Zener diode.

In accordance with a third aspect of the present application, a controlling circuit is provided. The controlling circuit has a front-stage circuit generating an output signal in response to a control of an input voltage, a switch signal and a modulation signal, a comparator electrically connected to the front-stage circuit for comparing the output signal from the front-stage circuit with an output signal from a current amplifier and generating a reset signal in response to a compared result, a latch circuit electrically connected to the comparator for generating an output signal in response to a control of the reset signal and a set signal, a clock generator electrically connected to the front-stage circuit and the latch circuit to generate the modulation signal and the set signal, and a differential amplifier electrically connected to the step-down circuit and generating an output signal in response to a control of an output voltage from the step-down circuit and a reference voltage.

Preferably, the set signal has a first waveform with a first low-potential pulse while being in a heavy-load state to prevent the reset signal from being changed in response to the output signal from the latch circuit while the set signal functions, for preventing an error operation of the converter resulting from erroneously comparing an output signal from the front-stage circuit with the output signal from the current amplifier, and the set signal has a second waveform with a second low-potential pulse while being in a light-load state to set a minimum time of operation for driving the converter into a power-saving mode, a driving circuit electrically connected to the latch circuit and generating a driving signal in response to the output signal from the latch circuit, so as to drive a switch to generate a switch signal for controlling the current amplifier and a step-down circuit.

Preferably, the controlling circuit is used for controlling a pulse width modulated DC/DC converter.

Preferably, the front-stage circuit has a current amplifier generating an output signal in response to a control of the input voltage and the switch signal, and a compensator electrically connected to the current amplifier and generating the output signal from the front-stage circuit in response to the output signal from the current amplifier and the modulation signal.

Preferably, the current amplifier has a non-inverting input terminal and an inverting input terminal and a resistor is connected therebetween, and the input voltage is input to the non-inverting input terminal of the current amplifier.

Preferably, the switch signal is input to the inverting input terminal of the current amplifier.

Preferably, the modulation signal is a sawtooth wave.

In accordance with a fourth aspect of the present application, a controlling circuit is provided. The controlling circuit has a front-stage circuit generating an output signal in response to a control of an input voltage, a switch signal and a modulation signal, a comparator electrically connected to the front-stage circuit for comparing the output signal from the front-stage circuit with an output signal from a current amplifier and generating a reset signal in response to a compared result, a latch circuit electrically connected to the comparator for generating an output signal in response to a control of the reset signal and a set signal, a clock generator electrically connected to the front-stage circuit and the latch circuit to generate the modulation signal and the set signal, a post-stage circuit electrically connected to the latch circuit and generating the switch signal in response to the output signal from the latch circuit for controlling the front-stage circuit, and a differential amplifier electrically connected to the post-stage circuit and generating an output signal in response to a control of an output voltage from the post-stage circuit and a reference voltage.

Preferably, the set signal has a first waveform with a first low-potential pulse while being in a heavy-load state to prevent the reset signal from being changed in response to the output signal from the latch circuit while the set signal functions, for preventing an error operation of the converter resulting from erroneously comparing an output signal from the front-stage circuit with the output signal from the current amplifier, and the set signal has a second waveform with a second low-potential pulse while being in a light-load state to set a minimum time of operation for driving the converter into a power-saving mode.

Preferably, the controlling circuit is used for controlling a pulse width modulated DC/DC converter.

Preferably, the post-stage circuit has a driving circuit electrically connected to the latch circuit for generating a driving signal in response to the output signal from the latch circuit, a switch electrically connected to the driving circuit for driving a switch in response to the driving signal to generate the switch signal for controlling the front-stage circuit, and a step-down circuit electrically connected to the switch for generating an output voltage from the post-stage circuit in response to the driving signal.

Preferably, the switch is a MOSFET (metal oxide semiconductor field effect transistor).

Preferably, the step-down circuit has an inductor, a Zener diode and a capacitor.

Preferably, the inductor has two ends respectively connected to a cathode end of the Zener diode and a first end of the capacitor and a second end of the capacitor is connected to an anode end of the Zener diode.

In accordance with a fifth aspect of the present application, a method for controlling a pulse width modulated DC/DC converter is provided. The method has steps of widening a low-potential pulse of a set signal to prevent an error operation of the DC/DC converter while in a heavy-load state, and re-widening the low-potential pulse of a set signal to set a minimum time of operation for driving the DC/DC converter into a power-saving mode.

Preferably, the DC/DC converter has a clock generator for generating the set signal.

Preferably, the clock generator is capable of generating a set signal of a modulatable width.

The foregoing and other features and advantages of the present application will be more clearly understood through the following descriptions with reference to the drawings, in which:

### BRIEF DESCRIPTION OF THE DRAWINGS

FIG. 1 is a diagram illustrating the conventional controlling circuit for a pulse width modulated DC/DC converter according to the prior art;

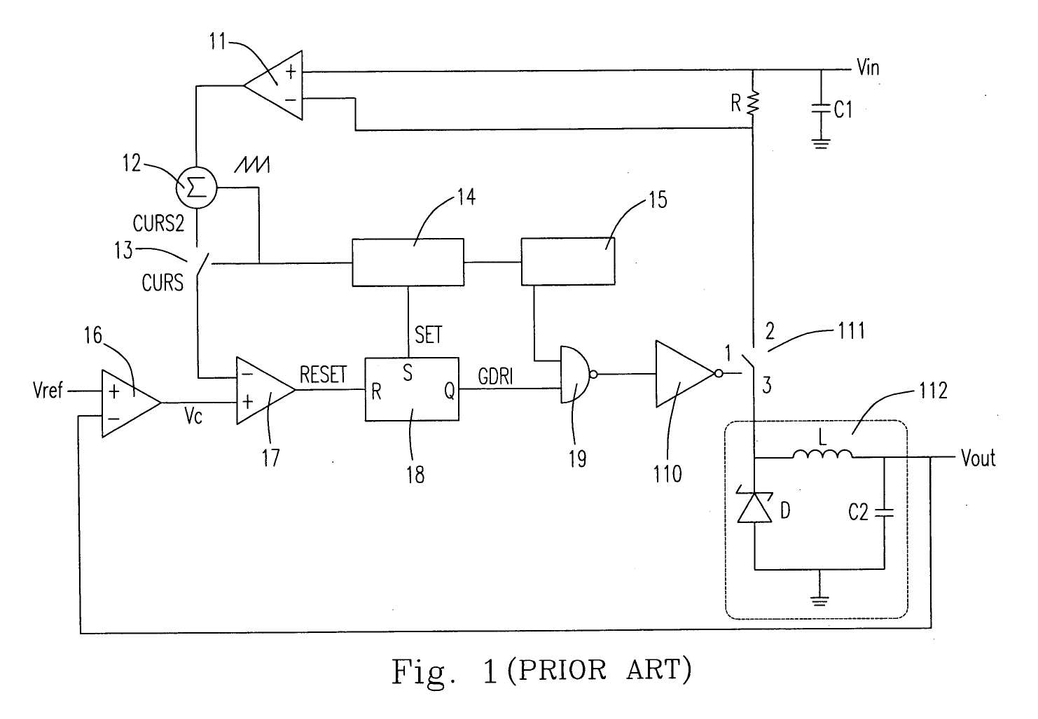

FIG. 2 is a diagram illustrating the measured waveforms of various output signals consisting of V_{C}, CURS2, CURS, SET, RESET and GDRI in the conventional controlling circuit shown in FIG. 1;

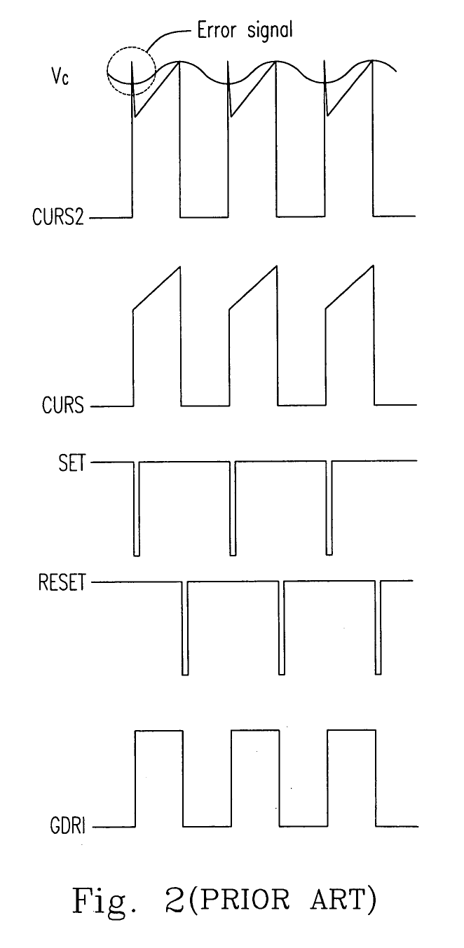

FIG. 3 is a diagram illustrating the controlling circuit for the pulse width modulated DC/DC converter according to a preferred embodiment of the present application;

FIG. 4 is a diagram illustrating the measured waveforms of various output signals consisting of V_{C}, CURS, SET, RESET and GDRI in the controlling circuit shown in FIG. 3; and

FIG. 5 is a diagram illustrating the waveforms measured of various output signals consisting of V_{C}, CURS, SET, RESET and GDRI while the converter according to the present application is operated in various operating modes.

### DETAILED DESCRIPTION OF THE PREFERRED EMBODIMENT

The present application will now be described more specifically with reference to the following embodiments. It is to be noted that the following descriptions of preferred embodiments of this application are presented herein for purpose of illustration and description only; it is not intended to be exhaustive or to be limited to the precise form disclosed.

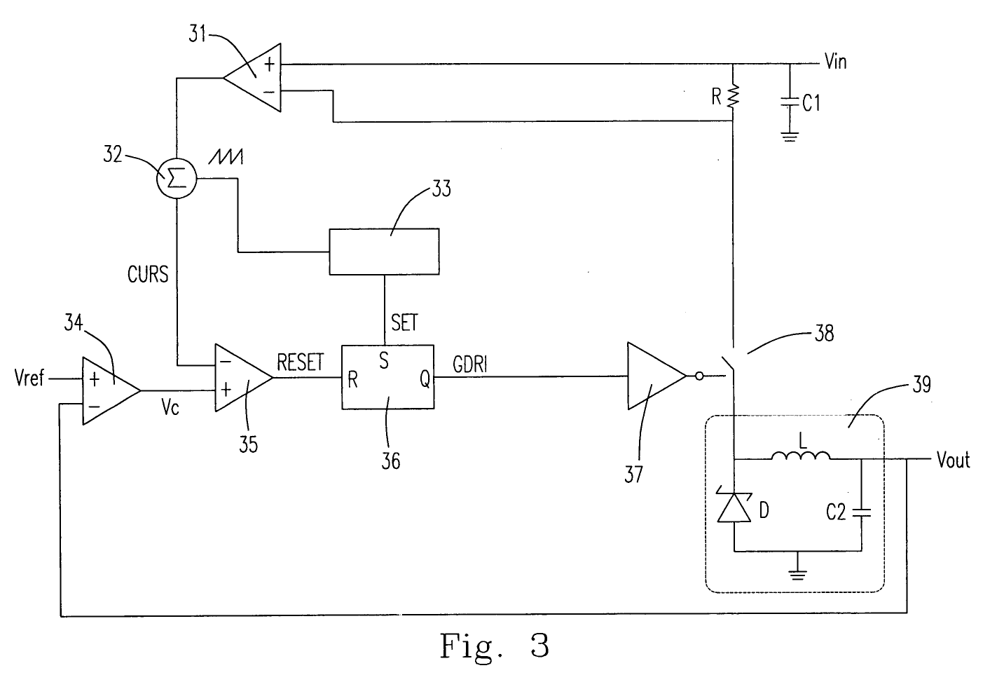

Please refer to FIG. 3, which is a diagram illustrating the controlling circuit for the pulse width modulated DC/DC converter according to a preferred embodiment of the present application. The controlling circuit has the current amplifier 31, the compensator 32, the clock generator 33, the differential amplifier 34, the comparator 35, the R-S latch circuit 36, the driving circuit 37, the switch 38 and the step-down circuit 39. The current amplifier 31 has an output terminal electrically connected to an input terminal of the compensator 32, and another input terminal and an output terminal thereof are respectively electrically connected to the clock generator 33 and an inverting input terminal of the comparator 35. The output terminal of the comparator 35 is connected to the R-S latch circuit 36. The clock generator 33 is electrically connected between the compensator 32 and the R-S latch circuit 36. An output signal GDRI from the R-S latch circuit 36 is received and input into the driving circuit 37, and accordingly, the driving circuit 37 generates a driving signal forwarded to the switch 38. Additionally, the switch 38 has a first terminal electrically connected to the driving circuit 37, and a second terminal and a third terminal respectively connected to an inverting input terminal of the current amplifier 31 and the step-down circuit 39. The differential amplifier 34 is configured to receive an output voltage Vₒᵤₜ from the step-down circuit 39 and a reference voltage V_{ref}, and accordingly generates a compared voltage V_{C} forwarded to the nono-inverting input terminal of the comparator 35.

The step-down circuit 39 is constructed of an inductor L, a Zener diode D and a capacitor C2, wherein the inductor L has two terminals respectively connected to a cathode of the Zener diode D and a first terminal of the capacitor C2, and a second terminal of the capacitor C2 is electrically connected to an anode of the Zener diode D. Furthermore, such a pulse width modulated DC/DC converter in this case is related to a current mode.

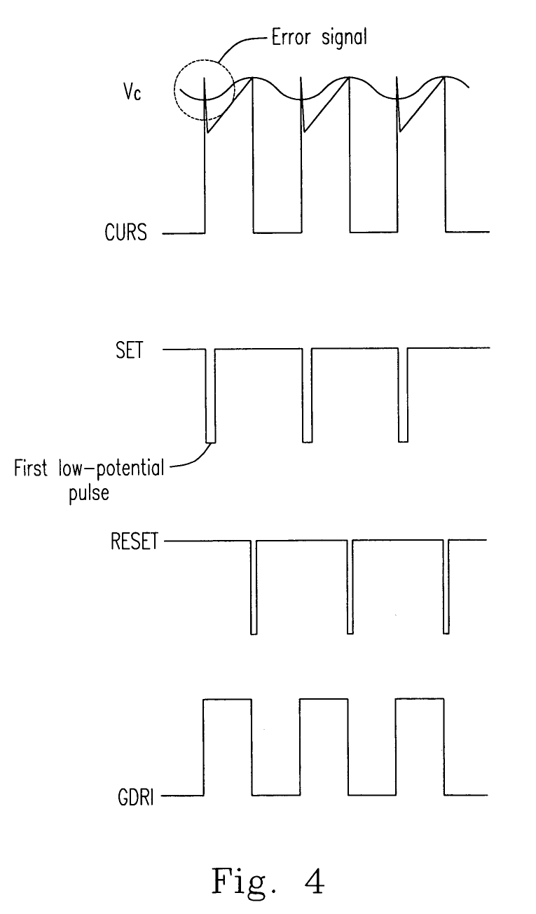

Please refer to FIG. 4 illustrating the measured waveforms of various output signals consisting of V_{C}, CURS, SET, RESET and GDRI in the controlling circuit shown in FIG. 3. A parasitic capacitance is induced between the gate and the drain of the switch 38 due that the switch 38 is a MOSFET, and the charging effect of the parasitic capacitance further results in an error current signal and hence initiates an error operation of the converter.

In order to induce an effect of a proceeding shield for preventing the erroneous converter operating, an adjustable SET signal's width oscillator generator is applied for adjusting the pulse width in the DC/DC converter provided by the present application.

Referring to FIG. 3 and FIG. 4 again, the working principle of the provided DC/DC converter according to the present application is further illustrated as follows.

Firstly, the current amplifier 31 generates an output signal in response to an input voltage Vᵢₙ and a value come from the second terminal of the switch 38, and the output signal from the current amplifier 31 is input to the compensator 32 with a sawtooth wave generated by the clock generator 33. The compensator 32 generates an output signal CURS having a waveform as shown in FIG. 4 in response to the output signal from the current amplifier 31 and the sawtooth wave.

The output signal CURS is forwarded to the comparator 35, which compares the output signal CURS with the compared voltage V_{C} and accordingly generates a reset signal RESET, wherein the reset signal RESET is in a high-potential state if the compared voltage V_{C} has a higher potential than that of the output signal CURS and at a low-potential state if otherwise. Then the reset signal RESET and the set signal SET generated by the clock generator 33 are simultaneously input to the R-S latch circuit 36 and the R-S latch circuit 36 would generate an output signal GDRI, accordingly.

As shown in FIG. 4, the waveform of the output signal GDRI from the R-S latch circuit 36 is transformed while the set signal SET or the reset signal RESET transforms from a high-potential state into a low-potential state. In other words, the potential state of the output signal GDRI is transformed in response to a control of the set signal SET or the reset signal RESET.

The point worthy to be mentioned is that the potential of the output signal CURS would be higher than that of the compared voltage V_{C} while the charging effect of the parasitic capacitance occurs, which further results in an error current signal and hence initiates an error operation of the converter.

For overcoming such a problem, the adjustable SET signal's width oscillator generator is instead applied as the clock generator 33 in the controlling circuit. The clock generator 33 generates a set signal having a first waveform with a first low-potential pulse while in a heavy-load state to further set an operating time for shielding, and the width of first low-potential pulse is widened and adjusted based on the compared voltage V_{C}. While the shielding is induced, the reset signal RESET is prevented from being changed in response to the output signal GDRI from the R-S latch circuit 36 when the set signal SET operates. Hence the erroneous converter operating resulted from comparing an error signal from the compensator 32 with the compared voltage V_{C} from the differential amplifier 34 is prevented as a result.

On the other hand, the clock generator 33 would generate a set signal having a second waveform with a second low-potential pulse while being in a light-load state to set a minimum turn-on time of operation for driving the converter into a power-saving mode.

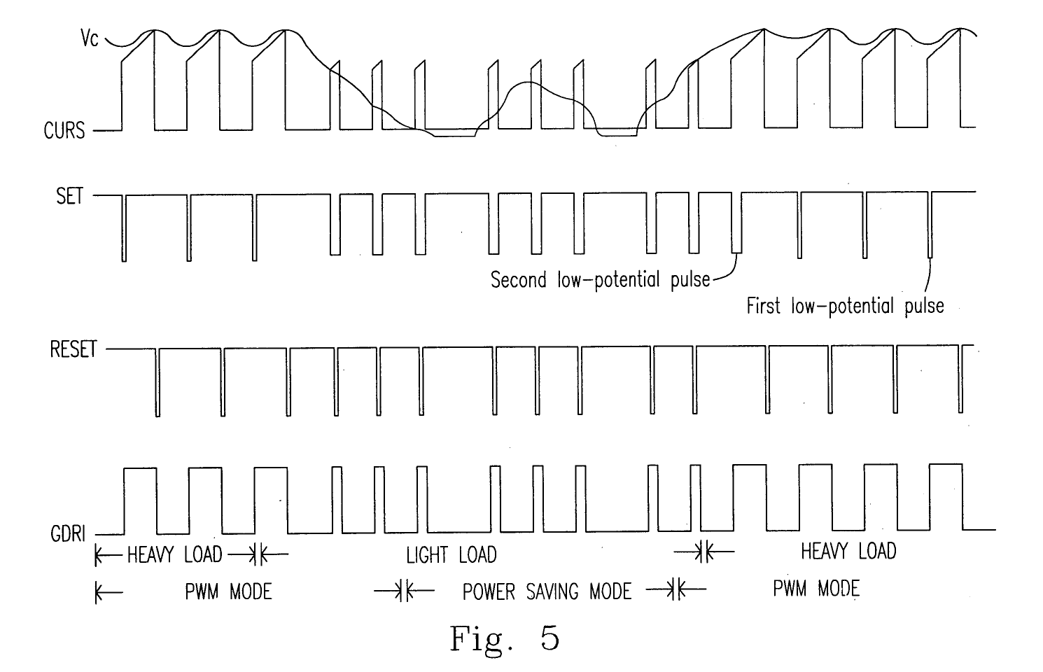

Please refer to FIG. 5, which illustrates the waveforms measured of various output signals consisting of V_{C}, CURS, SET, RESET and GDRI while the converter according to the present application is operated in various operating modes. The reset signal RESET would not change with the output signal GDRI from the R-S latch circuit 36 when the set signal SET operates, and hence the output signal GDRI from the R-S latch circuit 36 would not be changed even if the reset signal RESET exists while in a light-load state. It means that the output signal GDRI is not affected by the appearance of the reset signal RESET if the set signal SET is precisely controlled by the clock generator 33. Additionally, the second low-potential pulse has a width larger than that of the first low-potential pulse.

The controlling circuit provided by the present application further has a driving circuit 37 for driving the output signal GDRI from the R-S latch circuit 36 to control the switch 38, and moreover, to control the current amplifier 31 and the step-down circuit 39. The output voltage Vₒᵤₜ from the step-down circuit 39 is forwarded back to the differential amplifier 34 as an input with the reference voltage V_{ref}. Accordingly, the differential amplifier 34 would generate the compared voltage V_{C} in response to the reference voltage V_{C} and the output voltage Vₒᵤₜ from the step-down circuit 39, and the compared voltage V_{C} is further compared with the output signal CURS form the compensator 32 by the comparator 35 to make the pulse width modulation proceeding.

Based on the above, the controlling circuit provided by the present application for controlling a DC/DC converter utilizes a clock generator related to an adjustable SET signal's width oscillator generator. The clock generator generates a set signal SET having a first waveform with a first widened low-potential pulse while being in a heavy-load state a second waveform with a widened second low-potential pulse while being in a light-load state to set a minimum time of operation for preventing an error operation of the converter and driving the converter into a power-saving mode. An additional circuit and switches are needless in the present application, which is more compact than the conventional ones. Hence, the present application not only has a novelty and a progressiveness, but also has an industry utility.

While the application has been described in terms of what is presently considered to be the most practical and preferred embodiment, it is to be understood that the application needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

1. A controlling circuit, comprising:
a current amplifier outputting an output signal in response to an input voltage;
a compensator electrically connected to said current amplifier and generating an output signal in response to said output signal from said current amplifier and a modulation signal;
a comparator electrically connected to said compensator for comparing said output signal from said compensator with said output signal from said current amplifier and generating a reset signal in response to a compared result;
a latch circuit electrically connected to said comparator and generating an output signal in response to a control of said reset signal and a set signal;
a clock generator electrically connected to said compensator and said latch circuit to generate said modulation signal and said set signal, wherein said set signal has a first waveform with a first low-potential pulse while in a heavy-load state to prevent said reset signal from being changed in response to said output signal from said latch circuit while said set signal functions, for preventing an error operation of said converter resulting from erroneously comparing an output signal from said compensator with said output signal from said current amplifier, and said set signal has a second waveform with a second low-potential pulse while in a light-load state to set a minimum time of operation for driving said converter into a power-saving mode;
a driving circuit electrically connected to said latch circuit and generating a driving signal in response to said output signal from said latch circuit, so as to drive a switch to generate a switch signal for controlling said current amplifier and a step-down circuit; and
a differential amplifier electrically connected to said step-down circuit and generating an output signal in response to a control of an output voltage from said step-down circuit and a reference voltage.

2. The controlling circuit according to claim 1 for controlling a pulse width modulated DC/DC converter.

3. The controlling circuit according to claim 2, wherein said current amplifier has a non-inverting input terminal and an inverting input terminal, a resistor is connected therebetween and said input voltage is input to said non-inverting input terminal of said current amplifier.

4. The controlling circuit according to claim 1, wherein said switch signal is input to said inverting input terminal of said current amplifier.

5. The controlling circuit according to claim 1, wherein said modulated signal is a sawtooth wave.

6. The controlling circuit according to claim 1, wherein said latch circuit is an R-S latch circuit.

7. The controlling circuit according to claim 1, wherein said clock generator is capable of modulating a width of said set signal.

8. The controlling circuit according to claim 1, wherein said second low-potential pulse has a width larger than that of said first low-potential pulse.

9. The controlling circuit according to claim 1, wherein said switch is a MOSFET (metal oxide semiconductor field effect transistor).

10. The controlling circuit according to claim 1, wherein said step-down circuit comprises an inductor, a Zener diode and a capacitor.

11. The controlling circuit according to claim 1, wherein said inductor has two ends respectively connected to a cathode end of said Zener diode and a first end of said capacitor, and a second end of said capacitor is connected to an anode end of said Zener diode.

12. A controlling circuit, comprising:
a front-stage circuit generating an output signal in response to a control of an input voltage, a switch signal and a modulation signal;
a comparator electrically connected to said front-stage circuit for comparing said output signal from said front-stage circuit with an output signal from a current amplifier and generating a reset signal in response to a compared result;
a latch circuit electrically connected to said comparator for generating an output signal in response to a control of said reset signal and a set signal;
a clock generator electrically connected to said front-stage circuit and said latch circuit to generate said modulation signal and said set signal, wherein said set signal has a first waveform with a first low-potential pulse while in a heavy-load state to prevent said reset signal from changing in response to said output signal from said latch circuit while said set signal functions, for preventing an error operation of said converter resulting from erroneously comparing an output signal from said front-stage circuit with said output signal from said current amplifier, and said set signal has a second waveform with a second low-potential pulse while in a light-load state to set a minimum time of operation for driving said converter into a power-saving mode;
a driving circuit electrically connected to said latch circuit and generating a driving signal in response to said output signal from said latch circuit, so as to drive a switch to generate a switch signal for controlling said current amplifier and a step-down circuit; and
a differential amplifier electrically connected to said step-down circuit and generating an output signal in response to a control of an output voltage from said step-down circuit and a reference voltage.

13. The controlling circuit according to claim 12 for controlling a pulse width modulated DC/DC converter.

14. The controlling circuit according to claim 13, wherein said front-stage circuit comprises:
a current amplifier generating an output signal in response to a control of said input voltage and said switch signal; and
a compensator electrically connected to said current amplifier and generating said output signal from said front-stage circuit in response to said output signal from said current amplifier and said modulation signal.

15. The controlling circuit according to claim 14, wherein said current amplifier has a non-inverting input terminal and an inverting input terminal, a resistor is connected therebetween and said input voltage is input to said non-inverting input terminal of said current amplifier.

16. The controlling circuit according to claim 14, wherein said switch signal is input to said inverting input terminal of said current amplifier.

17. The controlling circuit according to claim 14, wherein said modulation signal is a sawtooth wave.

18. A controlling circuit, comprising:
a front-stage circuit generating an output signal in response to a control of an input voltage, a switch signal and a modulation signal;
a comparator electrically connected to said front-stage circuit for comparing said output signal from said front-stage circuit with an output signal from a current amplifier and generating a reset signal in response to a compared result;
a latch circuit electrically connected to said comparator for generating an output signal in response to a control of said reset signal and a set signal;
a clock generator electrically connected to said front-stage circuit and said latch circuit to generate said modulation signal and said set signal, wherein said set signal has a first waveform with a first low-potential pulse while in a heavy-load state to prevent said reset signal from changing in response to said output signal from said latch circuit while said set signal functions, for preventing an error operation of said converter resulting from erroneously comparing an output signal from said front-stage circuit with said output signal from said current amplifier, and said set signal has a second waveform with a second low-potential pulse while in a light-load state to set a minimum time of operation for driving said converter into a power-saving mode;
a post-stage circuit electrically connected to said latch circuit and generating said switch signal in response to said output signal from said latch circuit for controlling said front-stage circuit; and
a differential amplifier electrically connected to said post-stage circuit and generating an output signal in response to a control of an output voltage from said post-stage circuit and a reference voltage.

19. The controlling circuit according to claim 18 for controlling a pulse width modulated DC/DC converter.

20. The controlling circuit according to claim 19, wherein said post-stage circuit comprises:
a driving circuit electrically connected to said latch circuit for generating a driving signal in response to said output signal from said latch circuit;
a switch electrically connected to said driving circuit for driving a switch in response to said driving signal to generate said switch signal for controlling said front-stage circuit; and
a step-down circuit electrically connected to said switch for generating an output voltage from said post-stage circuit in response to said driving signal.

21. The controlling circuit according to claim 20, wherein said switch is a MOSFET (metal oxide semiconductor field effect transistor).

22. The controlling circuit according to claim 20, wherein said step-down circuit comprises an inductor, a Zener diode and a capacitor.

23. The controlling circuit according to claim 20, wherein said inductor has two ends respectively connected to a cathode end of said Zener diode and a first end of said capacitor and a second end of said capacitor is connected to an anode end of said Zener diode.

24. A clock generator for a set signal with a modulatable width for using in a controlling circuit of a pulse width modulated DC/DC converter, generating a set signal for controlling said DC/DC converter, wherein said set signal has a first waveform with a first low-potential pulse while in a heavy-load state to prevent an error operation of said DC/DC converter and a second waveform of a second low-potential pulse while in a light-load state to set a minimum time of operation for driving said converter into a power-saving mode.

25. The clock generator according to claim 24, wherein said second low-potential pulse has a width larger than that of said first low-potential pulse.

26. A method for controlling a pulse width modulated DC/DC converter, wherein said DC/DC converter has a clock generator for generating a set signal, comprising steps of:
widening a low-potential pulse of said set signal to prevent an error operation of said DC/DC converter while in a heavy-load state; and
re-widening said low-potential pulse of said set signal to set a minimum time of operation for driving said DC/DC converter into a power-saving mode.

27. The method according to claim 26, wherein said clock generator is capable of generating a set signal of a modulatable width.
